(19) United States
(12) Patent Application Publication
(10) Pub. No.: US 2022/0096306 A1
(43) Pub. Date: Mar. 31, 2022

(54) DECOMPRESSION DEVICE AND METHOD

(71) Applicant: Thomas A. Bilek, Vancouver, WA (US)

(72) Inventor: Thomas A. Bilek, Vancouver, WA (US)

(21) Appl. No.: 17/547,410

(22) Filed: Dec. 10, 2021

Related U.S. Application Data
(63) Continuation-in-part of application No. 16/664,328, filed on Oct. 25, 2019.
Application No. 16/664,328 is a continuation-in-part of application No. 15/970,320, filed on May 3, 2018, now abandoned.
(60) Provisional application No. 62/503,618, filed on May 9, 2017.
(60) Provisional application No. 62/522,965, filed on Jun. 21, 2017.
(60) Provisional application No. 62/769,062, filed on Nov. 19, 2018.

(51) Int. Cl. A61H 1/02

(52) U.S. Cl. CPC A61H 1/0229; A61H 2201/1652; A61H 2201/1253; A61H 2201/1621; A61H 2201/1676; A61H 2205/081

(57) ABSTRACT

A decompression device and a method using the decompression device are provided. The device includes a support structure having a longitudinal brace, and a cross brace that may be coupled to or part of the longitudinal brace. A harness may be coupled to the cross brace, and the harness may have a traction surface. An adjustable fastener may control the harness length therein controlling the distance between the traction surface and the first cross brace. The base positioned on a surface or structure, and portions of the harness positioned around the body of a user, such as under the arms and around the back. The user may manipulate the adjustable fastener to position portions of the harness a desired distance from the cross brace. The user may then leans forwards tilting the decompression device and the harness will provide lift, and therefore decompression, to the back of the body of a user.

### CROSS REFERENCE TO RELATED APPLICATIONS

This application is a CIP of Ser. No. 16/664,328, filed on Oct. 25, 2019, which claims benefit of Ser. No. 62/769,062, filed on Nov. 19, 2018, and which is a CIP of Ser. No. 15/970,320, filed on May 3, 2018 which claims benefit of Ser. No. 62/503,618, filed on May 9, 2017 and claims benefit of Ser. No. 62/522,965, filed on Jun. 21, 2017, all of which are incorporated by reference in their entirety.

### FIELD OF THE INVENTION

This patent specification relates to the field of therapeutic orthopedic devices. More specifically, this patent specification relates to devices and methods configured to provide decompression to a body.

### BACKGROUND

Many individuals suffer from chronic back pain. While surgery, drug therapy, and chiropractic manipulation are employed for the treatment of back pain, the use of traction or decompression therapy and back stretching is preferable to many individuals. Decompression therapy may help relieve many types of pains including lower back, neck, and radiating leg and arm pain. Spinal or back decompression therapy decompresses spinal discs and facet joints by utilizing traction, distraction, and body positioning.

Some devices for providing decompression therapy require permanent installation in a building or a large, sturdy framework. However, these devices are typically costly, not portable, and/or not suitable for home use or travel. Other decompression therapy devices rely on being attached to a structure that is capable of supporting all or a percentage of the weight of a user. Unfortunately, users may not be readily able to attach the devices to such structures due to their back pain. Other users may incorrectly attach the devices resulting in the risk of falling and further injury. Still other decompression therapy devices rely on the user being immobile for periods of time which can be uncomfortable and undesirable for many people.

Therefore, a need exists for novel portable devices configured to provide decompression to a body. There is also a need for novel decompression therapy devices which do not require permanent installation in a building or a large, sturdy framework. A further need exists, for novel decompression therapy devices which do not require the user to attach the device to various structures that are capable of supporting all or a percentage of the weight. Finally, a need exists for novel decompression therapy devices that do not require the user to be immobile for periods of time.

### BRIEF SUMMARY OF THE INVENTION

A decompression device and method are provided which are configured to provide decompression to the body of a user. The device includes a support structure having a longitudinal brace. The longitudinal brace may have a longitudinal axis, an upper end, and a lower end, and a base may be coupled to the lower end. A cross brace may be coupled to the upper end, and the cross brace may have a latitudinal axis. Preferably, the latitudinal axis may be angled relative to the longitudinal axis between 75 and 115 degrees. A strap guide may be coupled to the cross brace, the strap guide forming a strap aperture on the cross brace. A harness having a length passing through the strap aperture on the cross brace, the harness arranged as a harness loop and configured to extend around a back portion of an upright torso of a user, in which the harness is configured to provide lift and decompression to the torso of the user when the user has positioned the harness around the back portion of their upright torso and the user leans/bends forward tilting the decompression device with their torso substantially parallel to the longitudinal axis.

In some embodiments, a method for back stretching using a decompression device may include the steps of: positioning the harness loop to extend around a back portion of an upright torso of a user; placing a contact surface of the base on a support object so that the cross brace is positioned above a head and the upright torso of the user; and leaning the user's head and front shoulders/clavicle over the base while maintaining the longitudinal axis to be substantially parallel with the user's torso.

In further embodiments, the device may comprise a positional motivator which may be configured to govern the distance that the traction surface may be positioned from the support structure. The device may include a support structure having a first cross brace. A harness having a traction surface may be movably coupled to the first cross brace. A positional motivator may couple the harness to the support structure, optionally via an extension. The positional motivator may be configured to control the distance between the traction surface and the first cross brace.

In still further embodiments, the device may include a positional motivator which may be configured to govern the distance that the base may be positioned from the support structure. The device may include a support structure having a first cross brace. A harness having a traction surface may be coupled to the first cross brace. A base may be movably coupled to the support structure via a positional motivator, and the positional motivator may be configured to control the distance between the base and the first cross brace. By controlling the distance between the base and the first cross brace, the positional motivator may also control the distance between the base and the traction surface.

In yet further embodiments, a decompression device may include: a support structure having a first cross brace; a harness coupled to the first cross brace of the support structure, the harness having a length; and an adjustable fastener coupled to the harness, the adjustable fastener configured to control the harness length; and a base attached to a lower portion of the support structure.

In still yet further embodiments, a decompression device may include: a support structure having a first cross brace; an adjustable fastener coupled to the support structure; a harness, having a length, coupled to the adjustable fastener, the adjustable fastener configured to control the harness length from the first cross brace; and a base coupled to a lower portion of the support structure.

In still yet further embodiments, a decompression device may include a traction surface, and portions of the harness and/or cushion may form the traction surface.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 depicts a front perspective view of an example of a decompression device according to various embodiments described herein.

FIG. 2illustrates a rear perspective view of an example of a decompression device according to various embodiments described herein.

FIG. 3shows a front perspective view of another example of a decompression device according to various embodiments described herein.

FIG. 4depicts a front perspective view of yet another example of a decompression device according to various embodiments described herein.

FIG. 5 illustrates a front perspective view of a further example of a decompression device according to various embodiments described herein.

FIG. 6 shows a rear perspective view of still another example of a decompression device in use according to various embodiments described herein.

FIG. 7 depicts a front perspective view of yet another example of a decompression device being used by a user according to various embodiments described herein.

FIG. 8 illustrates a rear perspective view of yet a further example of a decompression device according to various embodiments described herein.

FIG. 9 shows a front perspective view of yet a further example of a decompression device according to various embodiments described herein.

FIG. 10 depicts a front perspective view of still a further example of a decompression device according to various embodiments described herein.

FIG. 11 illustrates a front perspective view of yet a further example of a decompression device according to various embodiments described herein.

FIG. 12 shows a front perspective view of still yet a further example of a decompression device according to various embodiments described herein.

FIG. 13 depicts a side perspective view of yet another example of a decompression device according to various embodiments described herein.

FIG. 14 illustrates a side perspective view of still another example of a decompression device according to various embodiments described herein.

FIG. 15 shows a side perspective view of still yet another example of a decompression device according to various embodiments described herein.

FIG. 16 depicts a side perspective view of still a further example of a decompression device according to various embodiments described herein.

FIG. 17 illustrates a side perspective view of still yet a further example of a decompression device according to various embodiments described herein.

FIG. 18 shows a side perspective view of still yet another further example of a decompression device according to various embodiments described herein.

FIG. 19 depicts a perspective exploded view of an example base according to various embodiments described herein.

FIG. 20 illustrates a bottom plan view of a base and its contact surface according to various embodiments described herein.

FIG. 21 shows a perspective view of a sitting user using an example decompression device according to various embodiments described herein.

FIG. 22 depicts a perspective view of a standing user using an example decompression device according to various embodiments described herein.

FIG. 23 illustrates a block diagram of an example method for back stretching using a decompression device according to various embodiments described herein.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

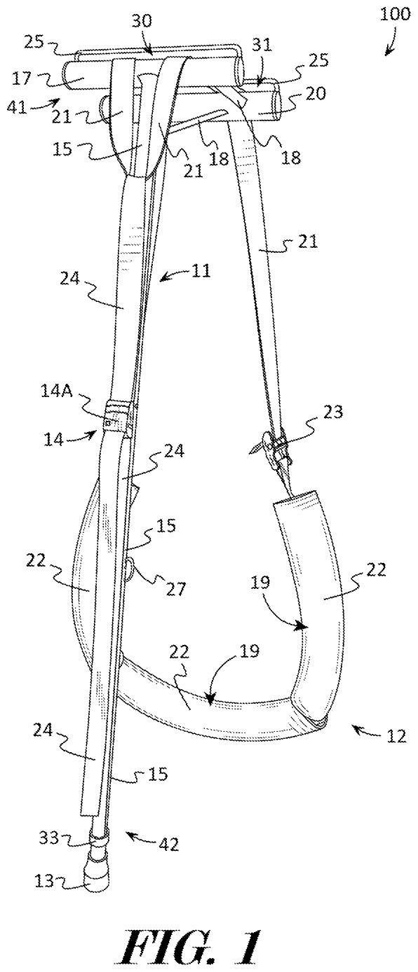

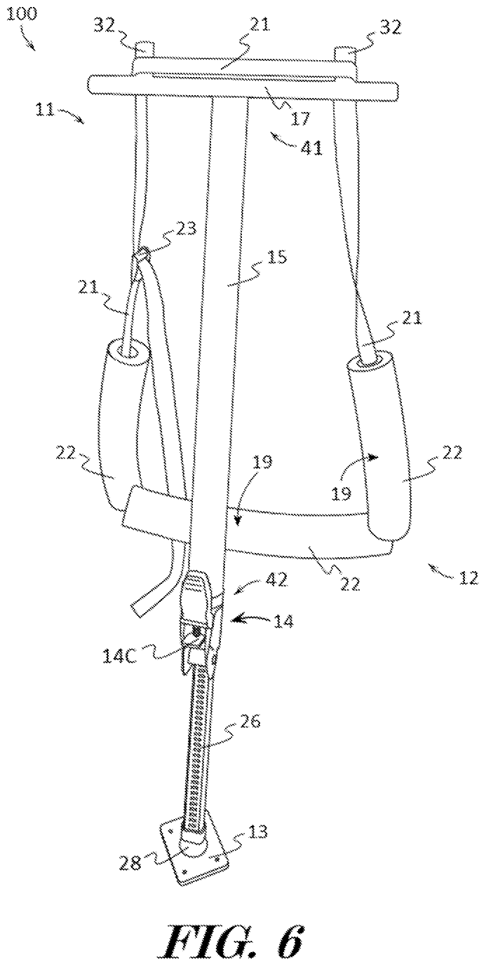

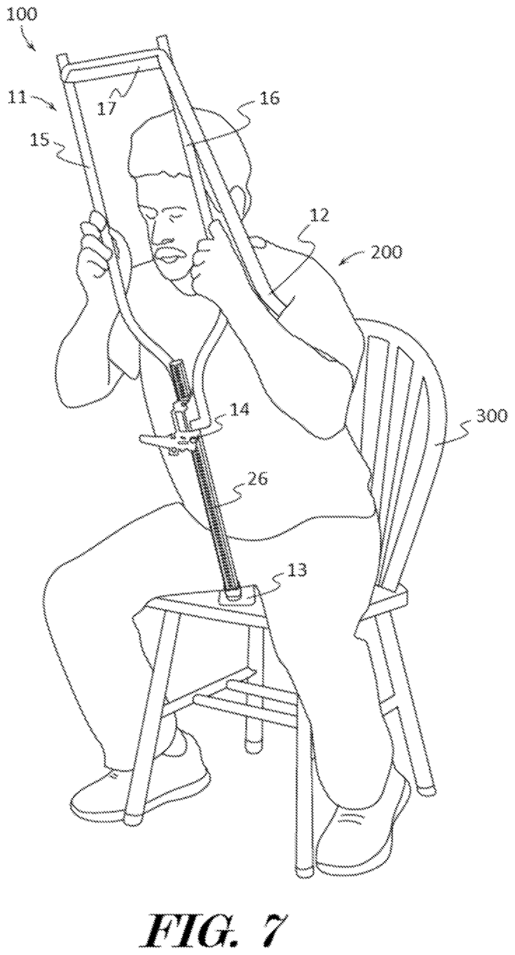

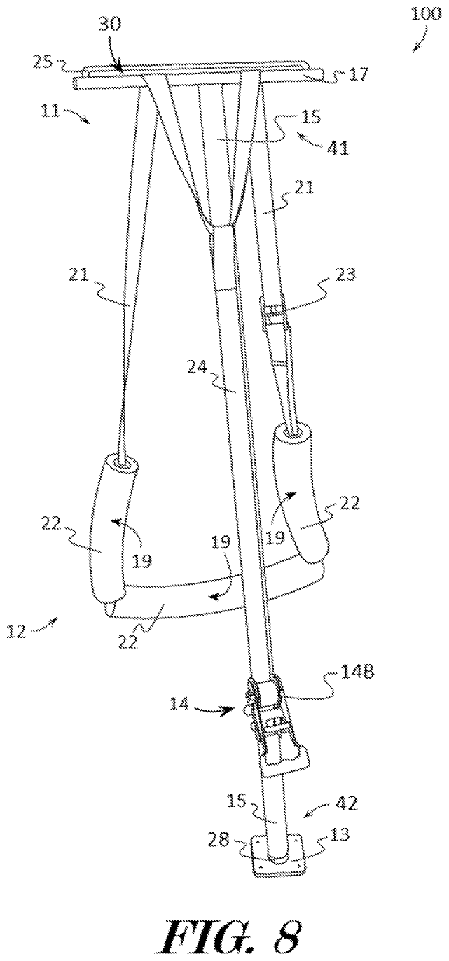

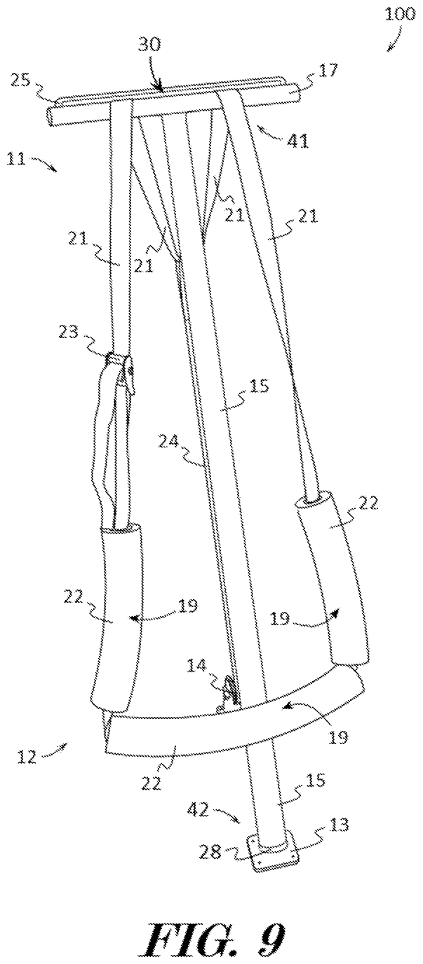

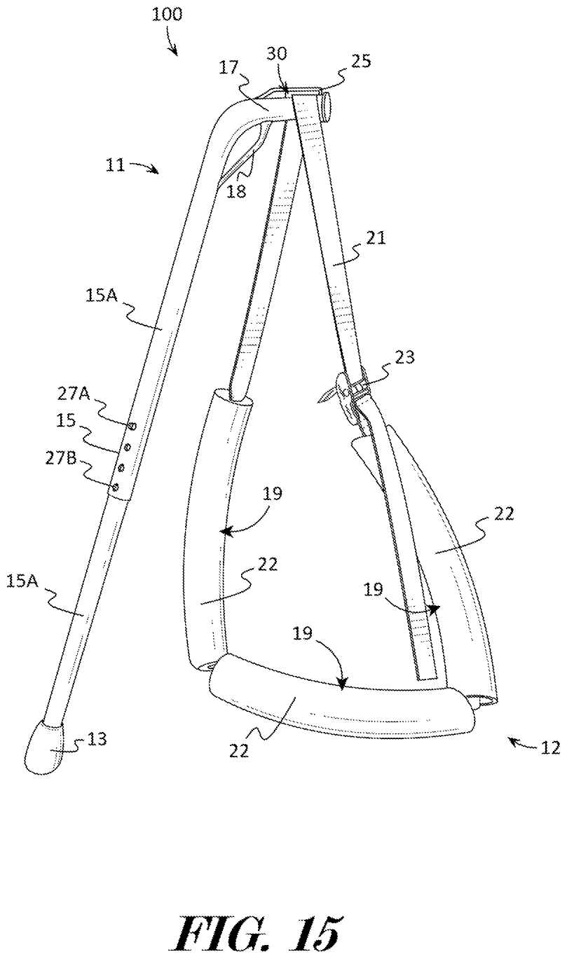

For purposes of description herein, the terms “upper”, “lower”, “left”, “center”, “right”, “rear”, “front”, “side”, “vertical”, “horizontal”, and derivatives thereof shall relate to the invention as oriented in FIGS. 1-18, 21, and 22. However, one will understand that the invention may assume various alternative orientations and step sequences, except where expressly specified to the contrary. Therefore, the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Although the terms “first”, “second”, etc. are used herein to describe various elements, these elements should not be limited by these terms. These terms are only used to distinguish one element from another element. For example, the first element may be designated as the second element, and the second element may be likewise designated as the first element without departing from the scope of the invention.

As used in this application, the term “about” or “approximately” refers to a range of values within plus or minus 10% of the specified number. Additionally, as used in this application, the term “substantially” means that the actual value is within about 10% of the actual desired value, particularly within about 5% of the actual desired value and especially within about 1% of the actual desired value of any variable, element or limit set forth herein.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

A new device and method configured to provide decompression to a body is discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

The present invention will now be described by example and through referencing the appended figures representing preferred and alternative embodiments. FIGS. 1-17, 18, 21, and 22 illustrate examples of a decompression device (“the device”) 100 according to various embodiments. In some embodiments, the device 100 may comprise a support structure 11 to which a harness 12 and a base 13 may be coupled. The harness 12 may comprise a traction surface 19 and an adjustable fastener 23 which may be positioned around portions of the body of a user 200. A positional motivator 14 may also be coupled to the support structure 11. The adjustable fastener 23 and/or positional motivator 14 may be configured to control the distance between the base 13 and the traction surface 19 of the harness 12. The base 13 may be positioned on a surface or structure, and the traction surface 19 may be positioned around the body of a user 200, such as under the arms and around the back. The user 200 may manipulate the adjustable fastener 23 and/or positional motivator 14 to position the traction surface 19 a desired distance from the base 13 and may position the base 13 on a support object 300. The user 200 may then lean portions of their body tilting the decompression device 100 causing the harness 12 traction surface 19 to provide lift to portions of the body contacted by the traction surface 19 resulting in decompression forces being applied to the body of the user 200.

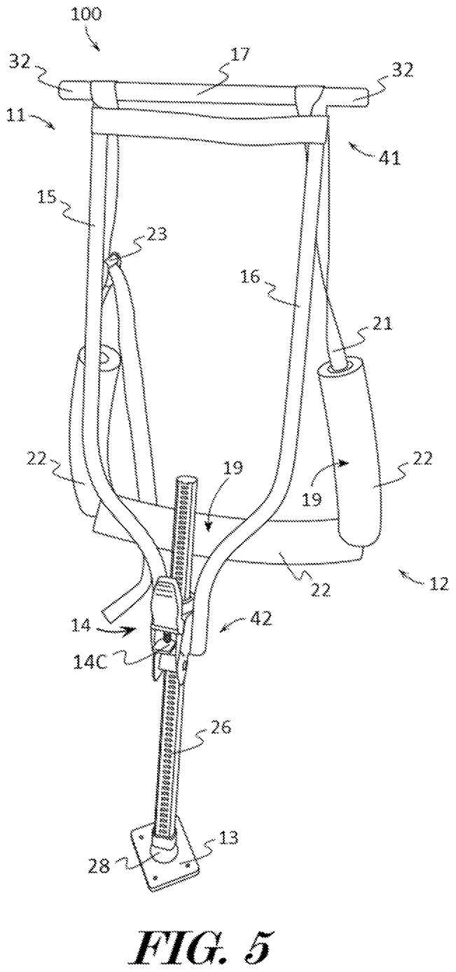

The support structure 11 may form a framework upon which the elements of the device 100 may be positioned and also which may transfer all or portions of the weight of a user 200 to the base 13. In some embodiments, the harness 12 may be coupled to the support structure 11 by coupling the harness 12 to a positional motivator 14 that is coupled to the support structure 11 as shown in FIGS. 1-4, 8, and 9-12. In other embodiments, the harness 12 may be coupled directly to the support structure 11 as shown in FIGS. 5-7, 13-18, 21, 22.

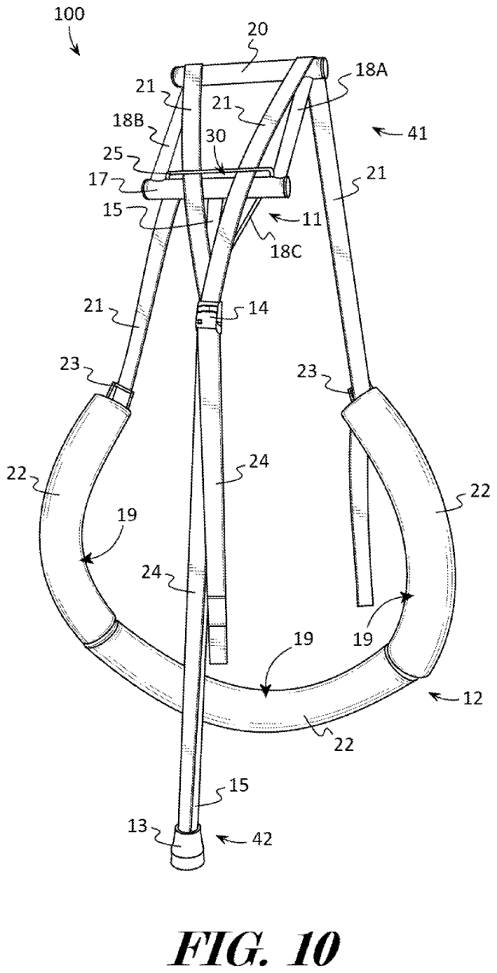

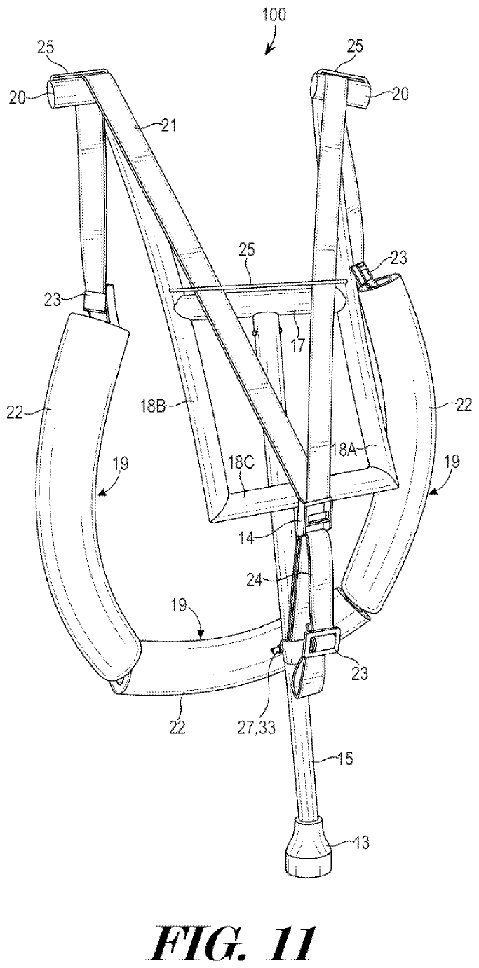

The support structure 11 may comprise an upper end 41 and an opposing lower end 42. Preferably, a harness 12 may be coupled starting from the upper end 41 while a base 13 may be coupled to or proximate to the lower end 42. A positional motivator 14 may be coupled anywhere on the device 100 and preferably to the support structure 11 directly or indirectly, such as via an extension 24. An extension 24 may comprise a length of nylon webbing, rope, chain, cable, or any other preferably flexible material or structure. In some embodiments, the support structure 11 may comprise one or more braces, such as a first longitudinal brace 15, a second longitudinal brace 16, a first cross brace 17, a second cross brace 20, a lateral brace(s) 18, and/or any number of other braces, which may be assembled and coupled together to form the support structure 11. A lateral brace(s) 18 may be used to couple and or support one or more other braces 15, 16, 17, 18, 20, together. For example, a lateral brace 18 may be configured as a first major lateral brace 18A (FIGS. 10 and 11) or a second major lateral brace 18B (FIGS. 10 and 11) which may be configured to couple a first cross brace 17 and a second cross brace 20 together. As another example, a lateral brace 18 may be configured as a third lateral brace 18C (FIGS. 10 and 11) which may be configured to couple and support first major lateral brace 18A or a second major lateral brace 18B to the first longitudinal brace 15 and thereby supporting cross brace 20.

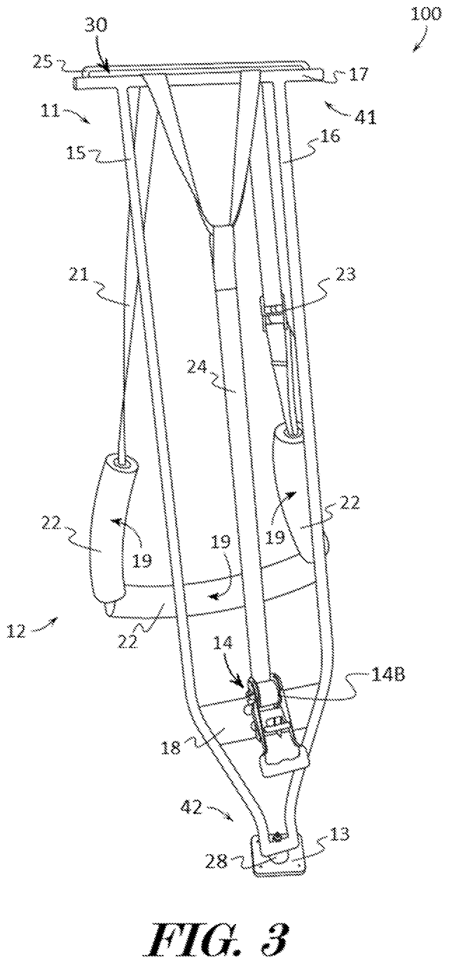

The device 100 may comprise one or more cross braces 17, 20. Generally, a cross brace 17, 20, may be disposed at the upper end 41 of the support structure 11 and may function as a fulcrum and/or an attachment point for the harness 12. In some embodiments, the device 100 may comprise a first cross brace 17 and a second cross brace 20 which may be coupled to the upper end 41 of the support structure 11 as shown in FIGS. 1, 2, 10, and 11. Preferably, the first cross brace 17 and second cross brace 20 may be oriented generally parallel to each other and may be separated by one or more lateral braces 18 a distance of between approximately 1.0 and 8.0 inches, and more preferably between 3.0 and 4.5 inches when cross braces 17, 20, are horizontal to each other. In other embodiments, a second cross brace 20 may be coupled above a first cross brace 17, such as at an angle as shown in FIGS. 10 and 11, thereby increasing the length of lateral brace 18. In other embodiments, the device 100 may comprise a single or first cross brace 17 which may be coupled to the upper end 41 of the support structure 11 as shown in FIGS. 3-9, 12, and 13-18, 21, 22.

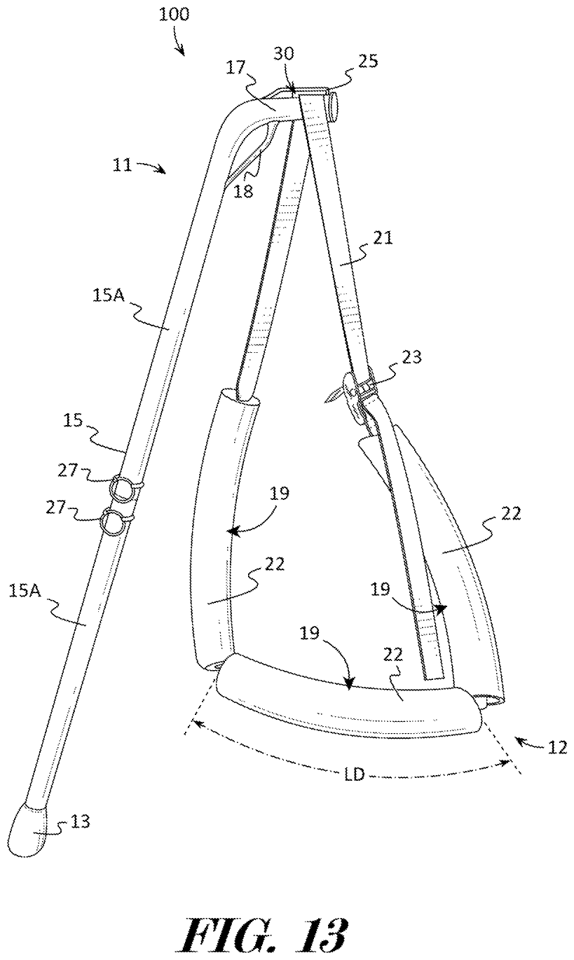

The device 100 may comprise one or more longitudinal braces 15, 16. Generally, a longitudinal brace 15, 16, may be used to couple elements at the upper end 41 of the support structure 11, such as brace(s) 17, 18, 20, to elements at the lower end 42 of the support structure 11, such as a positional motivator 14, beam 26, and/or base 13. In some embodiments, the device 100 may comprise a first longitudinal brace 15 and a second longitudinal brace 16 which may be coupled to the upper end 41 of the support structure 11 as shown in FIGS. 3-5, 7, and 12. In further embodiments, the device 100 may comprise a first longitudinal brace 15 which may be coupled to the upper end 41 of the support structure 11 as shown in FIGS. 1, 2, 6, 8, 9-11. In further embodiments first longitudinal brace 15 maybe part of the upper end of the support structure as shown in FIGS. 13-18, 21, 22. In still further embodiments, a first longitudinal brace 15 may couple a first cross brace 17 to the base 13 as shown in FIGS. 1, 2, 8, 9-11, and 18, 21, 22, or with second longitudinal brace 16 as shown in FIGS. 3, 4, and 12. In still further embodiments, a first longitudinal brace 15 may couple a first cross brace 17 to the base 13 with a positional motivator 14 as shown in FIGS. 5-7. Optionally, a longitudinal brace 15, 16, (or any other brace(s) 17, 18, 20,) may be configured to be adjustable in length and/or may comprise one or more removable sections by having a brace coupling 27. A brace coupling 27 may comprise any type of removable fastener, such as a pin with pull ring as shown in FIGS. 1, 2, 10, and 13, a bolt or other threaded fastener, a ball and detent mechanism, and a turn-to-lock connection method. Optionally and as shown in FIG. 11, a brace coupling 27 and anchor fastener 33 may be combined as a single element in which the anchor fastener 33 is holding or securing extension 24.

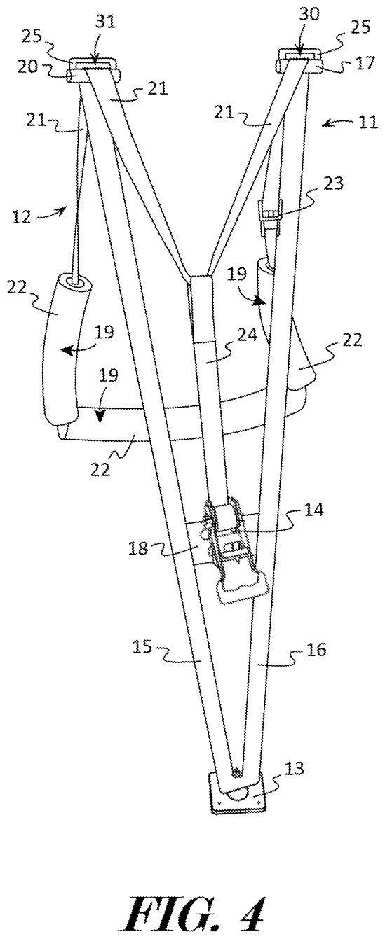

It should be understood that the support structure 11 may be configured with any number of braces 15, 16, 17, 18, 20. For example, a support structure 11 may comprise a first longitudinal brace 15 combined with a second longitudinal brace 16 as shown in FIGS. 3-5, and 7, or as another example, cross braces 17 or 20 can be of multiple brace sections as shown in FIGS. 4, 11. In another example the support structure 11 may comprise a first longitudinal brace 15 alone and may be part of a first cross brace 17 as shown in FIGS. 13-18, 21, 22. In further examples first longitudinal brace 15 shown alone as shown in FIGS. 1, 2, 6, 8, and 9-11 which may be coupled together, when needed, with a first cross brace 17, a lateral brace 18, and/or any number of other braces. Braces 15, 16, 17, 18, 20, may be configured in any shape and size thereby forming a support structure in any shape and size. For example, the device 100 may comprise an elongated first longitudinal brace 15 and an elongated second longitudinal brace 16 which may be generally oriented parallel to each other and which may be coupled together with a first cross brace 17 and a lateral brace 18 which may be opposingly positioned on the ends of the longitudinal braces 15, 16. In another example, an upper or first cross brace 17 may be configured with a curved shape, such as by being curved in a concaved manner away from the user 200.

In some embodiments, a harness 12 may be movably coupled or otherwise maintained in contact with the support structure 11 with one or more strap apertures 30, 31. Generally, a strap aperture 30, 31, may form an opening, channel, or the like, through which portions of the harness 12 maybe positioned through and which may enable the portions of the harness 12 to freely move in and out or through the strap apertures 30, 31. In some embodiments, a strap aperture 30, 31, may be formed between a strap guide(s) 25 and a cross brace 17, 20, which may be coupled together. In further embodiments, the device 100 may comprise a first strap aperture 30, and portions of the harness 12 may be movably coupled within the first strap aperture 30 to a first cross brace 17 as shown in FIGS. 1-4, 8, and 9-18, 21, 22. In still further embodiments, the device 100 may comprise a second cross brace 20 and a second strap aperture 31, and portions of the harness 12 may be movably coupled within the second strap aperture 31 to the second cross brace 20. In other embodiments, a strap aperture 30, 31, and/or a strap guide 25 may comprise a hook, eyelet, pulley, or any other structure which may guide, limit, or restrain the movement of the harness 12 to or along the support structure 11. In further embodiments, the device 100 may comprise one or more anchor braces 32 which may be used to couple or to maintain the position of the harness 12 on a cross brace 17. Optionally, an anchor brace 32 maybe coupled to a cross brace 17 and which may extend away from the cross brace 17.

The support structure 11 may be made from or comprise steel alloys, aluminum, aluminum alloys, copper alloys, any other type of metal or metal alloy, any type of ceramic, earthenware, synthetic stone, various types of hard plastics, such as polyethylene (PE), polypropylene (PP) and polyvinyl chloride (PVC), polycarbonate, nylon, Poly(methyl methacrylate) (PMMA) also known as acrylic, melamine, hard rubbers, fiberglass, carbon fiber, resins, such as epoxy resin, wood, other plant based materials, or any other material including combinations of materials that are substantially rigid and suitable for supporting all or portions of the weight of a user. For example, the support structure 11 and/or braces 15, 16, 17, 18, 20, may comprise steel or aluminum tubing, plates, or bar stock. Optionally, the support structure 11 may be adjustable in size or shape, such as by one or more braces 15, 16, 17, 18, 20, which may be telescoping in structure or coupled together in a telescoping manner.

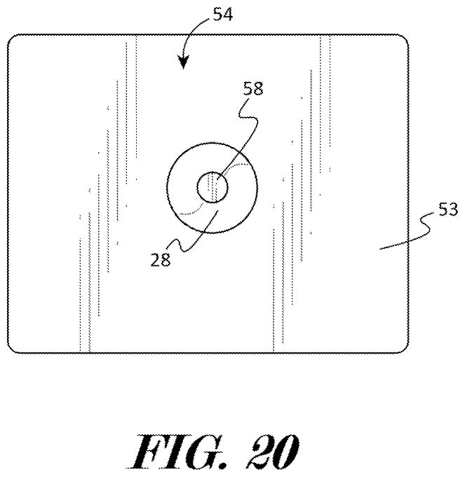

The device 100 comprises one base 13 which may be coupled directly to the support structure 11. As shown in FIGS. 1-3, 10,11, 13-17 when the base 13 is placed on a support object 300 it can pivot 360 degrees from the support object 300. In some embodiments the base may have an articulating joint to pivot from as shown in FIGS. 3-9, 12, 18-22. In further embodiments, a base 13 may be coupled to the support structure 11 by coupling the base 13 to a positional motivator 14 which is coupled to the support structure 11 as shown in FIGS. 5-7.

A harness 12 may comprise any apparatus or device which may be used to contact and support portions of the body of a user 200, such as around the back and under the arms. In its simplest form, a harness 12 can be made from a length of flexible material, such as rope, nylon webbing, leather strap, or the like, which may be positioned around the body of a user 200. In further embodiments, a harness 12 may be made from or may comprise a flexible material such as polypropylene webbing, polyester webbing, various types of flexible plastics such as polyvinyl chloride, natural rubber, neoprene foam rubber, synthetic rubber material such as latex rubber, forms of the organic compound isoprene, Polyacrylate Rubber, Ethylene-acrylate Rubber, Polyester Urethane, a flexible plastic such as high-density polyethylene (HDPE), polyvinyl chloride (PVC), polypropylene (PP), Polystyrene (PS), Polycarbonate (PC), low density polyethylene (LDPE), synthetic fabrics such as polyester, nylon, rayon, acetate, spandex, spandex blends, and Kevlar, and natural fabrics such as coir, cotton, hemp, jute, canvas, flax, leather, linen, ramie, wool, silk, or any other flexible material.

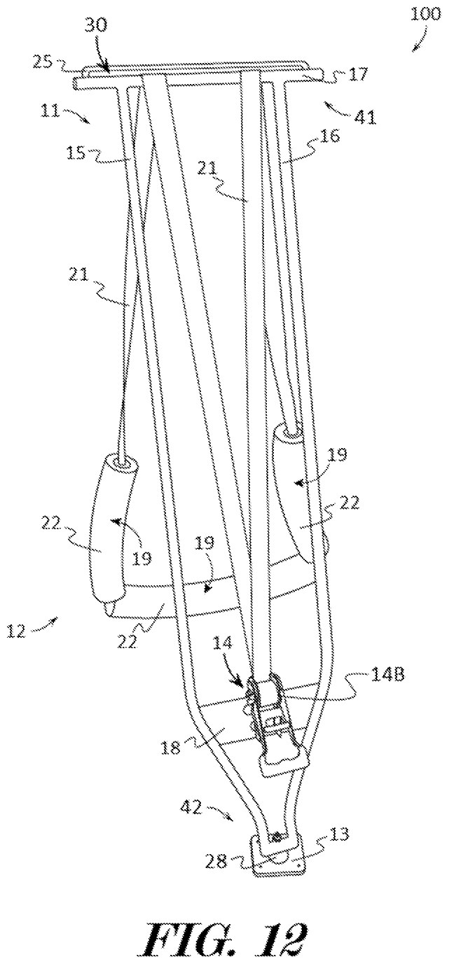

In preferred embodiments, a harness 12 may comprise one or more traction surfaces 19 which may form the portion of the harness 12 for contacting the user 200 and which may form the portion of the harness 12 which may be positioned a desired distance from the base 13 via an adjustable fastener 23 adjusting the length of the harness loop 21 or in other embodiments may have a positional motivator 14 as shown in FIGS. 12 or a combination thereof in FIGS. 1-11. Optionally, a traction surface 19 may be formed by the harness loop 21 and/or by a cushion 22. Preferably, a harness 12 may comprise a harness loop 21 which may be coupled directly to the support structure 11 or indirectly coupled to the support structure 11.

In preferred embodiments, the harness 12 may comprise one or more adjustable fasteners 23, such as buckles, claps, clips, snap fasteners, cam buckles, ratcheting buckles, hook-and-loop type fasteners, or any other fastener, which may be used to adjustably and/or removably couple one or more portions of the harness 12 together so that portions of the harness 12 may be adjustable in length. In further embodiments, an adjustable fastener 23 may comprise one or more side release buckles, buckles, clasps, slides, loops, reducers, cam buckles, strap adjusters, snap hooks, D rings, tri-loops, footman loops, keepers, cord locks, strap locks, or any other suitable means for adjusting the length of portions of the harness 12.

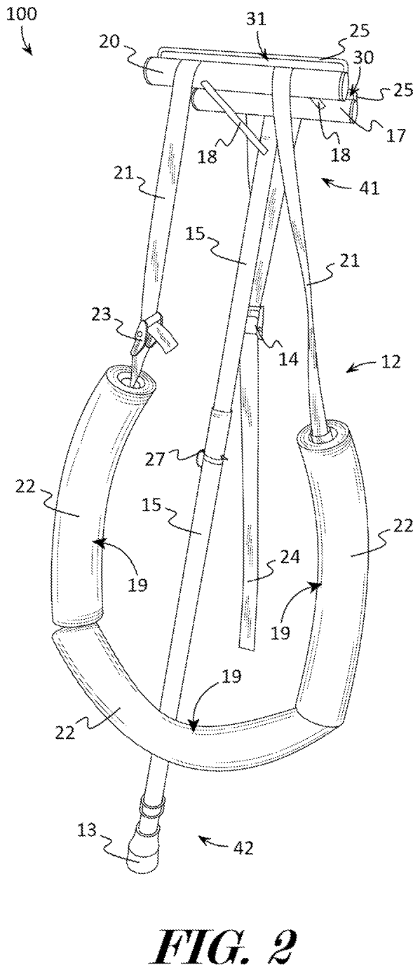

In some embodiments and as shown in FIGS. 1-4, and 8-12, the harness 12 may be operably coupled to a positional motivator 14 so that by operating the positional motivator 14, the distance between a traction surface 19 and the first cross brace 17 and/or a second cross brace 20 may be changed. In further embodiments, the harness loop 21 of the harness 12 may be operably coupled to a positional motivator 14 as shown in FIG. 12 the ends of harness 12 may directly connect to the positional motivator(s) 14 as shown in FIG. 12. In other embodiments, device 100 may comprise an extension 24 which may couple the harness loop 21 of the harness 12 to a positional motivator 14 so that the harness 12 may be operably coupled to a positional motivator 14 via the extension as shown in FIGS. 1-4, 8, and 9. In still other embodiments, a harness 12 may be operably coupled to a positional motivator 14 with any number or types of elements so that by operating the positional motivator 14, the distance between a traction surface 19 and the first cross brace 17 and/or a second cross brace 20 may be changed. In alternative embodiments and as shown in FIGS. 1, 2, 10, and 11, the harness 12 may be operably coupled to a positional motivator 14, and the positional motivator 14 may be coupled to the support structure 11, base 13, and/or other element of the device 100 via an extension 24. In yet further embodiments, the harness 12 may be operably coupled to a positional motivator 14 via an extension 24 which is coupled to the harness 12 and to the support structure 11, base 13, and/or other element of the device 100 as shown in FIGS. 1 and 2. In this example, the positional motivator 14 may comprise a hand operated ratchet 14B or cam buckle 14A and the ratchet type positional motivator 14 may tighten and loosen the extension 24 thereby decreasing and increasing the distance between the portions of the harness 12, such as a traction surface 19, and the base 13.

In some embodiments, the device 100 may comprise one or more cushions 22 which may be positioned around or coupled to one or more elements, such as braces 15, 16, 17, 18, a harness 12, and harness loop 21. In some embodiments, the device 100 may comprise two or more cushions 22.

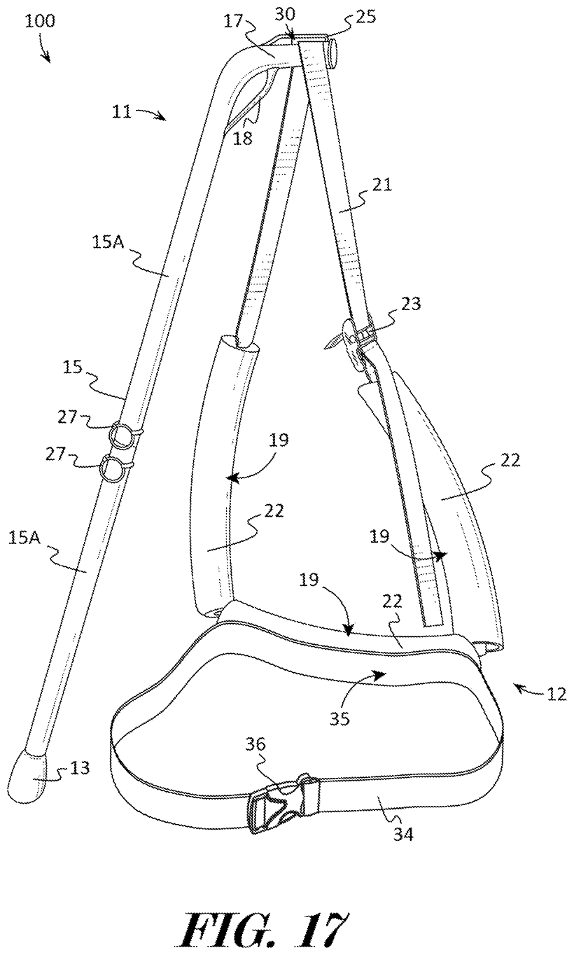

In some embodiments, and as shown in FIGS. 17, 18, 21, 22, the device 100 may comprise a belt 34 which may be configured to encircle a user's torso 202, such as by wrapping around the waist, hips, stomach, etc., of the user 200. Preferably, a belt 34 may comprise an interior surface 35, which may be configured to contact or wrap around the waist of a user 200, and a belt fastener 36 which may be configured to adjust the length of the belt 34 and, therefore, the amount of the interior surface 35 configured to contact or wrap around the waist of a user 200. A belt 34 may be coupled to the harness 12, a cushion 22, and/or a traction surface 19. The interior surface 35 of a belt 34 may function in a similar manner as a traction surface 19 so that tension applied to a portion of a user's body 200 by a harness 12, a cushion 22, and/or a traction surface 19 may also be communicated, via the interior surface 35, to the portion of the user's body 200 that the belt 34 may be positioned around. By adjusting the distance between a traction surface 19 and a first cross brace 17 (and/or base 13), the distance between an interior surface 35 of a belt 34 and a first cross brace 17 (and/or base 13) may likewise be adjusted. A belt 34 may be made from or may comprise a flexible material, such as nylon webbing, or any other flexible material, such as which may be used to form portions of a harness 12. Preferably, a belt 34 may comprise a first belt end 37 and a second belt end 38, and the first belt end 37 and second belt end 38 may be removably coupled together via a belt fastener 36. A belt fastener 36 may comprise one or more side release buckles, buckles, clasps, slides, loops, reducers, cam buckles, strap adjusters, snap hooks, D rings, tri-loops, footman loops, keepers, cord locks, strap locks, or any other suitable means for adjusting the length of portions of the belt 34.

In preferred embodiments, a harness 12 may comprise a cushion 22 which may be coupled to a harness loop 21 and extend over or surround portions of a harness loop 21 to form all or portions of a traction surface 19. A cushion 22 may be configured to absorb impacts or provide a resilient cushioning layer between an element of the device 100 and a user 200. In some embodiments, a cushion 22 may comprise one or more traction surfaces 19. In further embodiments, the device 100 may comprise one or more traction surfaces 19 which may be formed by one or more cushions 22 of a harness 12.

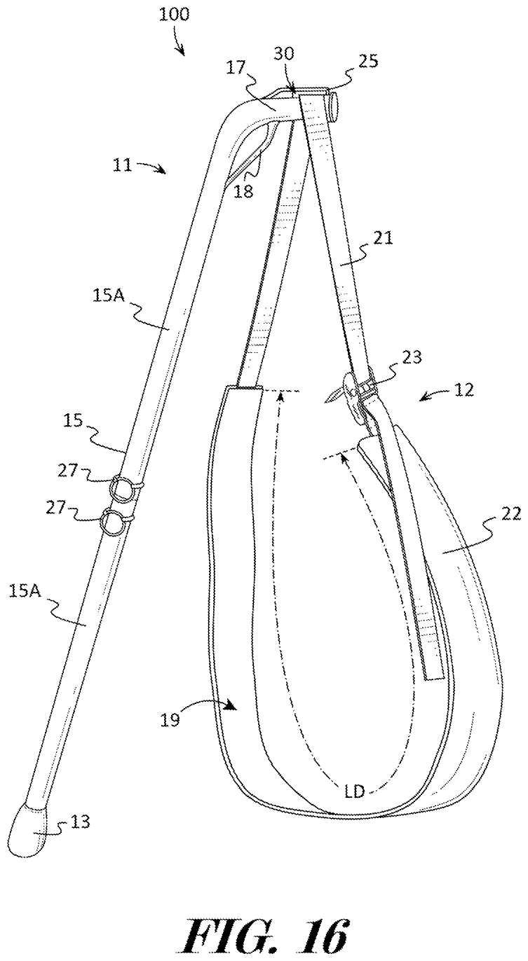

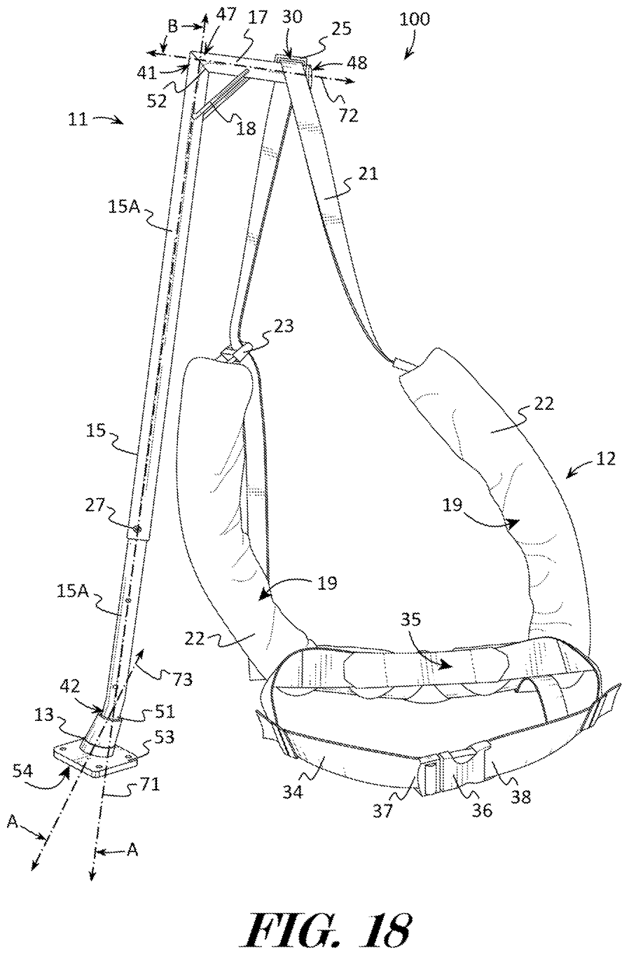

A traction surface 19 may be configured in any shape and size. For example, a traction surface 19 may be configured with a relatively smaller size as perhaps best shown in FIG. 13, or a traction surface 19 may be configured with a relatively longer size, such as a belt, as perhaps best shown in FIG. 16. For example, a traction surface 19 may comprise a length dimension (LD) and optionally may be configured or formed with smaller cushion 22 sections as shown FIG. 13 or as a single elongated cushion 22 as perhaps best shown in FIG. 16 with the length dimension (LD) of any size but preferably between 4.0 inches and 60.0 inches. A traction surface 19 may include or be part of interior surface 34 of belt 35 or any combination of examples. In some embodiments, the harness 12 may be configured as a loop (perhaps best shown in FIGS. 16 and 18), and the harness 12 may comprise a length which may be increased and decreased by the adjustable fastener 23. By increasing the size (diameter) of the loop the harness 12 length may be increased, and by decreasing the size of the loop the harness 12 length may be decreased.

In some embodiments, a cushion 22 may be made from or comprise a resilient material such as silicone foams, rubber foams, silicone rubber, urethane foams including plastic foams, neoprene foam, latex foam rubber, polyurethane foam rubber, or elastomer materials such as elastic plastics, elastic silicone, elastic rubbers, or any other suitable elastomer or resilient material including combinations of materials. Optionally, a cushion 22 may be covered or otherwise include a material, which is preferably impervious to water, such as rubber or flexible plastic, which may be used to further provide comfort to a user 200 and to protect the cushion 22 material from sweat, cleaning agents, and other contaminants. In some embodiments, the device may comprise two or more cushions 22, while in other embodiments, the device 100 may comprise a cushion 22 which maybe elongated and coupled to the harness loop 21 and configured to wrap around the waist of the user 200.

The device 100 may comprise one or more adjustable fasteners 23 or/and positional motivators 14 which may be configured to control the distance between a first cross brace 17 and a traction surface 19 of the harness 12. Generally, an adjustable fastener/positional motivator may comprise any apparatus or device which may be configured to control, such as by changing and maintaining, the distance between two elements, such as between the base 13 and portions of the harness 12.

In some embodiments and as shown in FIGS. 13-18, 21, 22, the device 100 may comprise an adjustable fastener 23 to govern the distance the traction surface 19 may be positioned from first cross brace 17 and the base 13. In further embodiments and as shown in FIGS. 5-7, 18, 21, 22, the adjustable fastener 23 may govern the distance between the traction surface 19 and the base 13. In still further embodiments and as shown in FIG. 12, the device 100 may comprise a positional motivator 14 which may be configured to govern the distance that the traction surface 19 may be positioned from a first cross brace 17. In further embodiments (FIGS. 1-11), an adjustable fastener 23 and/or a positional motivator 14 may govern the distance the traction surface 19 may be positioned from the first cross brace 17 and/or a second cross brace 20 (FIGS. 1, 2, 10, 11) of the support structure 11. In further embodiments, the device 100 may comprise a support structure 11 having a first cross brace 17. A harness 12 having a traction surface 19 may be movably coupled to the first cross brace 17 and/or second cross brace 20. A positional motivator 14 may couple the harness 12 to the support structure, optionally via an extension 24. The positional motivator 14 may be configured to control the distance between the traction surface 19 and the first cross brace 17 and/or second cross brace 20. For example, a positional motivator 14 may comprise a ratcheting buckle 14B which may be configured to tighten and loosen an extension 24 coupled to the to the harness 12 as shown in FIGS. 3, 4, 8, and 9. By decreasing the amount of extension 24 wound in the ratcheting buckle 14B, the distance between the traction surface 19 and the first cross brace 17 may be increased. Conversely, by increasing the amount of extension 24 wound in ratcheting buckle 14B the distance between the traction surface 19 and the first cross brace 17 may be decreased. As another example, a positional motivator 14 may comprise a cam buckle 14A (as shown in FIGS. 1, 2, 10, and 11) configured to be coupled with harness 12 and extension 24 and coupled with anchor fastener 33 (FIGS. 1 and 2). Generally, an anchor fastener 33 may comprise a crimp fastener, a threaded fastener, such as a screw or bolt, a rivet, a hook and loop fastener, or any other fastener which may be used to couple a positional motivator 14 to a support structure 11, base, 13, beam 26, or any other element of the device 100. By decreasing the amount of extension 24 fed through the cam buckle 14A type of positional motivator 14, the distance between the traction surface 19 and the cross brace 17, 20, may be increased. Conversely, by increasing the amount of extension 24 fed through the positional motivator 14, the distance between the traction surface 19 and a cross brace 17, 20, may be decreased.

In some embodiments and as shown in FIGS. 5-7, the device 100 may comprise a positional motivator 14 which may be configured to govern the distance that the base 13 may be positioned from the support structure 11. In further embodiments, the device 100 may comprise a support structure 11 having a first cross brace 17. A harness 12 having a traction surface 19 may be coupled to the first cross brace 17. Abase 13 may be movably coupled to the support structure 11 via a positional motivator 14, and the positional motivator 14 may be configured to control the distance between the base 13 and the first cross brace 17. By controlling the distance between the base 13 and the first cross brace 17, the positional motivator 14 may also control the distance between the base 13 and the traction surface 19. As an example, a positional motivator 14 may comprise a ratcheting jack 14C which may be configured to motivate a beam 26, to which the base may be coupled to, towards and away from the support structure 11. A ratcheting jack 14C may comprise a hand operated ratcheting jack or farm jack having a beam 26, to which the base 13 may be coupled, with a series of equally spaced holes along its length, and a hand operated mechanism which can be moved from one end of the beam 26 to the other through the use of a pair of climbing pins or any adjustable fastener. The ratcheting jack 14C type positional motivator 14 may retract and extend the beam 26 thereby decreasing and increasing the distance between the base 13 and the support structure 11 resulting in portions of the harness 12, such as a traction surface 19, being moved closer and farther from the base 13. By decreasing the distance that the base 13 is positioned away from the support structure 11, the distance between the traction surface 19 and the base 13 may be decreased. Conversely, by increasing the distance that the base 13 is positioned away from the support structure 11, the distance between the traction surface 19 and the base 13 may be increased.

While a positional motivator 14 has been illustrated as including or comprising a cam buckle 14A, ratcheting buckle 14B, and ratcheting jack 14C, a positional motivator 14 is not limited to these examples. In alternative embodiments, a positional motivator 14 may comprise a friction jack, hydraulic jack or pump, a ratcheting gear set or assembly, or any other hand operable apparatus which may be configured to both change and maintain the distance between two elements. In further alternative embodiments, a positional motivator 14 may comprise an actuator which may be operated by a source of energy, typically electric current, hydraulic fluid pressure, or pneumatic pressure, and converts that energy into motion. Examples of actuators may include comb drives, digital micromirror devices, solenoids, electric motors, electroactive polymers, hydraulic cylinders, piezoelectric actuators, pneumatic actuators, servomechanisms, thermal bimorphs, screw jacks, or any other type of hydraulic, pneumatic, electric, mechanical, thermal, and magnetic type of actuator.

FIGS. 13-18, 21, 22, depict further examples of a decompression device 100 according to various embodiments described herein. In some embodiments, the device 100 may comprise a support structure 11 having a first longitudinal brace 15 which may be elongated. The first longitudinal brace 15 may have a longitudinal axis 71, an upper end 41, and a lower end 42. A base 13 may be coupled to the lower end 42. A first cross brace 17 may be coupled to the upper end 41, and the first cross brace 17 may have a latitudinal axis 72. A strap guide 25 may be coupled to the first cross brace 17, and the strap guide 25 may have a strap aperture 30. The device 100 may include a harness 12, and the harness 12 may have a length passing through the strap aperture 30 on the first cross brace 17. The harness 12 may be arranged as a harness loop 21 and may be configured to extend around a back portion 201 of an upright torso 202 of a user 200, and with their torso 202 substantially parallel (plus or minus ten degrees) to the longitudinal axis 71 with the structure on a support object, the user 200 leans/bends forward with the support structure 11 causing weight to be transferred from the user 200, through the cushions 22 and harness 12 to the first cross brace 17 then to the base 13 and support object 300 as the upper body is lifted against gravity for decompression.

In further embodiments, the first longitudinal brace 15 may comprise a vertical tubular post structure approximately the height of a human torso 202 with a horizontal first cross brace 17 coupled at the upper end 41 that may be approximately 60% of a human head length. A base 13, optionally comprising a cane tip/foot or crutch foot base, may be coupled to the lower end 42 to provide a structure that the device 100 may tilt or pivot on. A harness 12 may be attached to the horizontal first cross brace 17 and extends down to a height that approximates the base 13 of the support structure 11. The user 202 preferably may wrap the loop 21 of the harness 12 around their lower back torso 202 as it passes under their arms. With the harness 12 length adjusted, the user 200 leans forward tilting the first longitudinal brace 15 and the first cross brace 17 causing the harness 12 to place upward and forward pressure on the lower back torso 202 against gravity stretching the torso 202, and therefor the back for decompression.

In further embodiments, the first longitudinal brace 15 may comprise a vertical tubular post structure with a vertical height that is approximately half the height of the user's body, with a horizontal first cross brace 17 coupled to the upper end 41 that is approximately half the length or less than the first longitudinal brace 15. A base 13 that approximates the size of a standing cane foot tip or smaller may be coupled to the lower end 42 of the first longitudinal brace 15 to provide a structure that the device 100 can rest on a supporting object 300 and can tilt from. A harness 12 may be attached to the horizontal first cross brace 17 and extends down to a height that approximates the base 13 of the device. The user 200 may wrap the loop 21 of the harness 12 around their lower back torso 202 as it passes under their arms. With the harness 12 length adjusted, the user 200 leans forward tilting the first longitudinal brace 15 and the first cross brace 17 placing upward pressure on the harness 12 against gravity lifting the user's torso 202, and therefore their back and spine, preferably the lumbar back and spine, upwards against gravity, while gravity remains below the harness pulling on the portions of lower back and spine below the harness 12 exerting decompression.

With the harness 12 length adjusted, the user 200 leans forward tilting the first longitudinal brace 15 and the first cross brace 17 causing the harness 12 to place upward pressure on the lower back torso 202 against gravity on the lower body of the user 200 stretching the torso 202, and therefor the back 201 for decompression.

Optionally, the first longitudinal brace 15 may comprise an angled lower extension 51 which may be angled relative to the longitudinal axis 71. An angled lower extension 51 may comprise 4-10% of the linear length of the first longitudinal brace 15. Preferably, the angled lower extension 51 may be angled away from the first cross brace 17 and so that the extension axis 73 is angled approximately between ten and twenty degrees, and more preferably between thirteen and seventeen degrees, relative to the longitudinal axis 71 as shown by angle A in FIG. 18.

A first cross brace 17 may be coupled to the first longitudinal brace 15. The first cross brace 17 may comprise a coupled end 47 and a free end 48. Preferably, the first cross brace 17 may be linear in shape having a latitudinal axis 72 that extends between the coupled end 47 and free end 48. The device 100 may comprise a brace junction 52 which may be formed at the junction or intersection between the coupled end 47 of the first cross brace 17 and the upper end 41 of the first longitudinal brace 15. The free end 48 may form the portion of the first cross brace 17 that is most distal to the first longitudinal brace 15. The free end 48 may be a ‘free end’ so as to not be coupled to any structural elements of the support structure 11. A free end 48 of the first cross brace 17 may extend out approximately 4 inches (60% of a human head length) from the first longitudinal brace 15 freeing space between the users face and the first longitudinal brace 15.

Preferably, the first cross brace 17 may be coupled to the first longitudinal brace 15 so that the first longitudinal brace 15 and the first cross brace 17 are angled at 90 degrees shown as B in FIG. 18, Alternatively, the angle could decrease or increase relative to each other so that the latitudinal axis 72 is angled approximately between 75 and 115 degrees to the longitudinal axis 71, the profile of the first cross brace 17 and first longitudinal brace 15 may generally resemble an L-shape or other approximately right angle coupling. Optionally, a lateral brace 18 may be coupled to both the first longitudinal brace 15 and first cross brace 17 so that the lateral brace 18 may structurally reinforce the brace junction 52 or joint between the first longitudinal brace 15 and first cross brace 17. In further embodiments (FIGS. 13-17), the top portion of the longitudinal brace 15 may be bent over creating the first cross brace 17.

A strap guide 25 may be coupled to the first cross brace 17, and the strap guide 25 may have a strap aperture 30, and a harness 12 may be movably coupled or otherwise maintained in contact with the support structure 11 by extending through the strap aperture 30. Generally, a strap aperture 30 may form an opening, channel, or the like, through which portions of the harness 12 maybe positioned through and which may enable the portions of the harness 12 to freely move in and out or through the strap apertures 30. Preferably, the device 100 may comprise a strap aperture 30 positioned proximate to the free end 48, and portions of the harness 12 may be movably coupled within the strap aperture 30 to the first cross brace 17 as shown in FIGS. 1-4, 8, and 9-18, 21, 22.

A base 13 may be coupled to the bottom end 42 of the first longitudinal brace 15, and the base 13 may be configured relatively small, such as a round cane tip or as large as 30 square inches having any shape such as square, rectangular shape, or a relatively larger oblong shape which may enable a user 200 to position portions of the base 13 on support objects 300. A base 13 may preferably comprise any durable and rigid material such metals, plastics and rubber or a combination thereof and have a traction surface of rubber or similar to prevent slippage on the support object 300 the base 13 is place upon. A base 13 may comprise a contact surface plate 53, and the contact surface plate 53 may have a surface area of less than or equal to 30 square inches. A contact surface plate 53 may be configured in any shape and may comprise the portion of the base 13 that contacts a support object 300. For example, a contact surface plate 53 may comprise a square shape having a length of six inches or less and a width of five inches or less or any other width and length that results in a surface area of less than or equal to 30 square inches. As another example, a contact surface plate 53 may comprise a circular shape having a diameter of 6.18 inches or less. The contact surface plate 53 may comprise a traction surface 54 for traction on a support object 300. The traction surface 54 may be made of rubber or similar traction enhancing, cushioning, and/or non-marring material, such as silicone, polyacrylate rubber, and other rubbers and plastics.

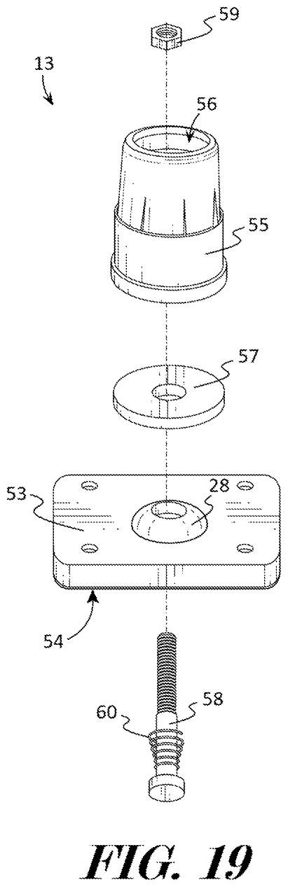

In preferred embodiments, a contact surface plate 53 of the base 13 may be movably coupled to the lower end 42 via an articulation joint 28 so that the contact surface 53 may pivot, rotate, or otherwise be moved relative to the first longitudinal brace 15 of the support structure 11. Preferably, the base 13 may be coupled to the support structure 11 with an articulation joint 28 which may comprise a ball joint, hinge, or other movable and/or flexible coupling. For example and referring to FIG. 19, the base 13 may comprise a contact surface plate 53, having a contact surface 54, and the contact surface plate 53 may have an articulation joint 28. The articulation joint 28 may have a convex hemi-spherical shape (extending away from the contact surface plate 53). A brace receiver 55 having a base aperture 56 may be coupled to the articulation joint 28 with an anti-friction plate 57 positioned between the brace receiver 55 and articulation joint 28. A male articulation fastener 58, such as a bolt, and a female articulation fastener 59, such as a nut, may couple the brace receiver 55, anti-friction plate 57, and articulation joint 28, and therefore the contact surface plate 53 together. Preferably, a tensioner 60, such as a spring, may enable a desired amount of play in the coupling between the brace receiver 55, anti-friction plate 57, and articulation joint 28, to allow a desired amount of movement resistance in the pivoting motion between the contact surface plate 53 and first longitudinal brace 15 enabled by the convex hemi-spherical shape of the articulation joint 28. Optionally, the base 13 may be coupled to a longitudinal brace 15 by press fitting the lower end 42 into the base aperture 56, although any other suitable coupling method may be used.

The harness loop 21 may be coupled to the first cross brace 17 via an adjustable fastener 23 or positional motivator(s) 14. In further embodiments, the harness loop 21 may be coupled to the first cross brace 17 so that the portions of the harness loop 21 that are coupled the harness loop 21 may be coupled to the first cross brace 17 may not be movable relative to the harness loop 21 may be coupled to the first cross brace 17. For example, the harness loop 21 may be coupled to the first cross brace 17 via a rivet type fastener, a threaded fastener, adhesive, heat bonding, etc. In other embodiments, the harness loop 21 may be coupled to the first cross brace 17 so that the harness loop 21 may be repositionable or movable relative to the portion of the first cross brace 17 that the harness loop 21 may be coupled to. For example, the device 100 may include a strap guide 25 coupled to the first cross brace 17 to form a first strap aperture 30, and the harness loop 21 may be inserted through the first strap aperture 30 so that portions of the harness loop 21 may be moved and repositioned through the first strap aperture 30 while preventing the harness loop 21 and first cross brace 17 from separating.

In some embodiments, the harness loop 21 may be configured with a fixed length or fixed dimensions so that the traction surfaces 19 of the one or more cushions 22 may have a fixed distance that they are capable of being moved away from the first cross brace 17 (since the harness loop 21 may be made from a flexible material, such as nylon webbing, the cushions 22 and harness loop 21 may not be limited in being moved towards the first cross brace 17).

In further embodiments, the harness loop 21 may be configured to be adjustable in length so that the harness loop 21 may be made larger and smaller, thereby allowing traction surfaces 19 of the one or more cushions 22 to be capable of being moved towards and away from the first cross brace 17. In preferred embodiments, a harness 12 may comprise one or more adjustable fasteners 23, such as a cam buckle, which may be configured to allow the harness loop 21 to be made larger and smaller. In further embodiments, the harness loop 21 may be coupled to the first cross brace 17 or other element of the device 100 with a positional motivator 14 that may be configured to increase and decrease the size of the harness loop 21 thereby allowing traction surfaces 19 of the one or more cushions 22 to be capable of being moved towards and away from the first cross brace 17.

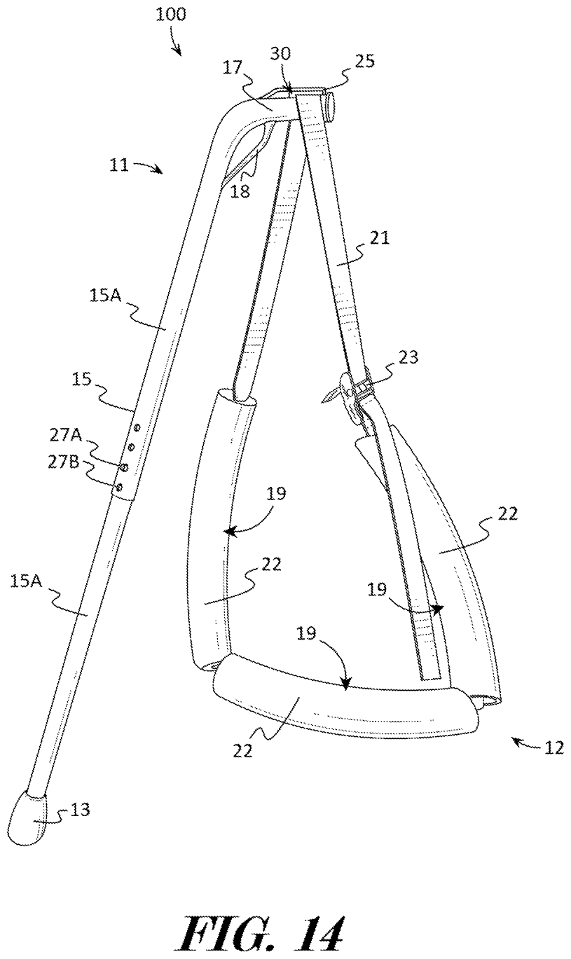

In some embodiments, the device 100 may comprise a first longitudinal brace 15 that may have a fixed length. In this manner, the distance between the first cross brace 17 and the base 13 may be fixed or not changeable. In other embodiments, a first longitudinal brace 15 may comprise two or more sections 15A which may allow the first longitudinal brace 15 to be adjustable in length. In preferred embodiments, a first longitudinal brace section 15A and a second longitudinal brace section 15A may be movably coupled together so that the first longitudinal brace section 15A may be extended from and retracted into the second longitudinal brace section 15A. For example, the first longitudinal brace 15 may comprise two sections 15A which may be removably and/or movably coupled together via one or more brace couplings 27 so that the sections 15A may be separated from each other so as to allow the device 100 to be moved into a compact state, such as for storage or travel. As another example, the first longitudinal brace 15 may comprise two or more sections 15A which may be configured to be telescoping so that portions of one section 15A may be retracted into and extended from another section 15A. A brace coupling 27 may comprise a ball detent arrangement commonly having a ball 27A sliding within a bored cylinder, against the pressure of a spring, which pushes the ball 27A against the other part of the mechanism, which carries the detent 27B, that can be as simple as a hole of smaller diameter than the ball. When the hole is in line with the cylinder, the ball 27A falls partially into the detent 27B hole under spring pressure, holding the brace sections 15A at that position. Additional force applied to the brace sections 15A will push the ball 27A back into its cylinder, compressing the spring, and allowing the brace sections 15A to move to another position, such as the relatively longer position shown in FIG. 13 and the relatively shorter position shown in FIG. 14.

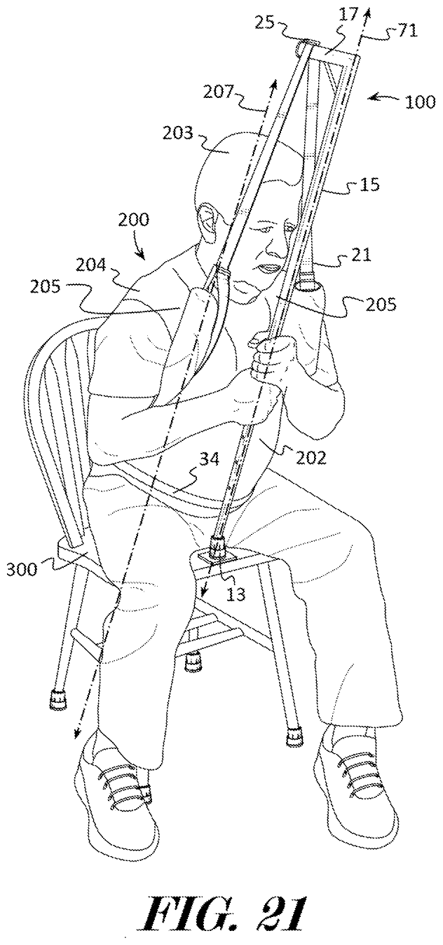

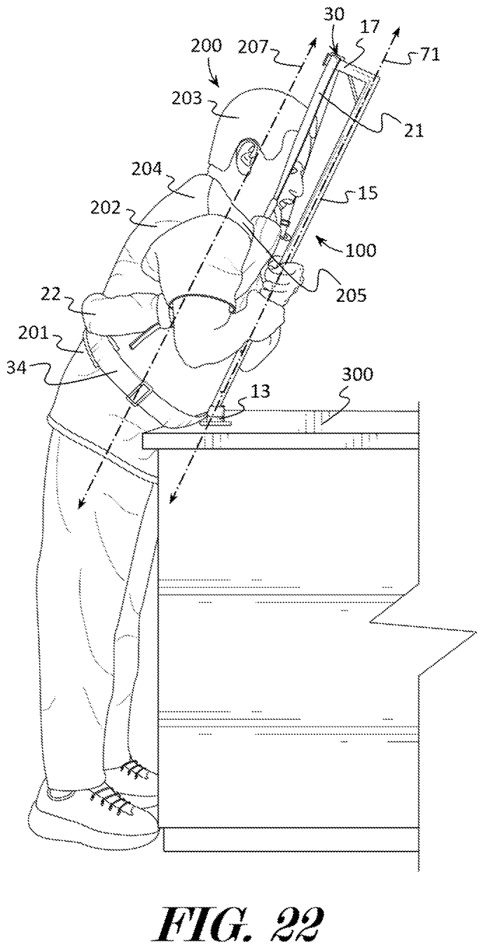

As best illustrated by FIGS. 21 and 22, the device 100 may be employed by a user 200 to provide decompression to the lumbar of their body. The user 200 may place portions of the harness 12, such as the traction surfaces 19, around their body for example, around the back portion 201 and below both arms, and also place the base 13 on a surface of a support object 300 suitable for supporting all or portions of the weight of the user 200. In the example of FIG. 21, the base 13 is being supported by a support object 300 comprising a chair. In the example of FIG. 22, the base 13 is being supported by a support object 300 comprising a counter. However, it should be understood that a support object 300 may comprise any object, suitable for supporting a portion of the body weight of a user 200, such as a work bench, kitchen counter top, table, picnic bench, weight bench, chair, ground or floor, etc., with the user 200 in various positions such as sitting, standing or kneeling. The user 200 may then manipulate the adjustable fastener 23 to select a desired distance between the portions of the harness 12, such as the traction surfaces 19, and the base 13. Once a desired distance between the portions of the harness 12 contacting the body and the base 13 is selected by the user 200 via the positional motivator 14, the user 200 may move or lean their body and the device 100, to vary the desired distance between the portions of the harness 12 and base 13 so that the device 100 may provide a selectable amount of decompression to the body.

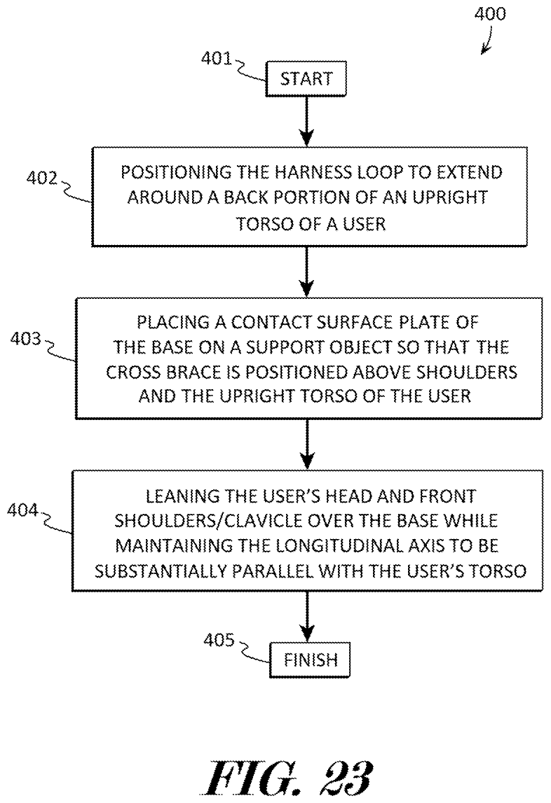

FIG. 23 provides a block diagram of a method for back decompression using a decompression device 100 (“the method”) 400 according to various embodiments described herein. Preferably, the method 400 may be performed using a device 100 comprising a support structure 11 having a longitudinal brace 15, the longitudinal brace 15 having a longitudinal axis 71, a upper end 41, and a lower end 42. A base 13 may be coupled to the lower end 42, and a cross brace 17 may be coupled to the upper end 41. The cross brace 17 may have a latitudinal axis 72, and the latitudinal axis 72 may be angled relative to the longitudinal axis 71 between approximately 75 and 115 degrees. A strap guide 25 may be coupled to the cross brace 17, and the strap guide 25 may form a strap aperture 30 on the cross brace 17. A harness 12 may be coupled to the cross brace 17 by the strap guide 25 with a length of the harness 12 passing through the strap aperture 30 on the cross brace 17, and the harness 12 may be arranged as a harness loop 21.

In some embodiments, the method 400 may start 401 and the harness loop 21 may be positioned to extend around a back portion 201 of an upright torso 202 of a user 200 in step 402 as perhaps best shown in FIGS. 21 and 22. In preferred embodiments, the device 100 may comprise a belt 34, and the belt 34 may be positioned to encircle and tighten around the user's torso 202, such as proximate to their waist.

In step 403, a contact surface plate 53 of the base 13 may be placed on a support object 300 so that the cross brace 17 is positioned above or higher than the head 203 and the upright torso 202 of the user 200 (FIGS. 21 and 22). In some embodiments FIGS. 4, 11 the cross brace 17 is positioned above the shoulders 204 of user 200. In further embodiments, the contact surface plate 53 of the base 13 may be placed on a support object 300 so that the cross brace 17 is positioned above the shoulders 204 and the upright torso 202 of the user 200.

In the example of FIG. 21, the support object 300 may comprise a chair that the user 200 may be sitting on, and the contact surface plate 53 of the base 13 may be placed on the seat of the chair with the longitudinal axis 71 substantially parallel with the user's torso 202 (shown by torso vertical axis 207) and with the cross brace 17 positioned above or higher than the user's head 203.

In the example of FIG. 22, the support object 300 may comprise a counter, such as a kitchen counter, that the user 200 may be standing next to, and the contact surface 53 of the base 13 may be placed on the counter with the longitudinal axis 71 substantially parallel with the user's torso 202 (shown by torso vertical axis 207) and with the cross brace 17 positioned above or higher than the user's head 203.

In step 404, the user's head 203 and front shoulders/clavicle 205 may be leaned or otherwise moved to be placed over the base 13 while maintaining the longitudinal axis 71 to be substantially parallel with the user's torso 202 (shown by torso vertical axis 207 in FIGS. 21 and 22). By leaning or otherwise moving the user's head 203 and front shoulders/clavicle 205 over the base 13 while maintaining the longitudinal axis 71 to be substantially parallel with the user's torso 202, the harness 12 may pull the user's torso 202 towards the cross brace 17 to provide lift and decompression to the user's torso 202, and therefore to their back and spine which are contained in the torso 202 of the user. By shortening the length of the harness loop 21, the lift and decompression provided to the user's torso 202 will be increased, while lengthening the length of the harness loop 21, will decrease the lift and decompression provided to the user's torso 202. In step 404, the harness 12 may lift upward from the top lumbar area of the user's torso 202, while gravity remains pulling the user's lower body downward from the lumbar region stretching the lower back lumbar to decompress the spine or lumbar vertebrae (elongating the spine vertically). In preferred embodiments, the device 100 may comprise an angled lower extension 51 forming the lower one to five inch, such as two inch, portion of the longitudinal brace 15, and the angled lower extension 51 may have between a 13 to 17 degree bend relative to the longitudinal brace 15 to enhance traction of the base 13 and its contact surface 52 when the user 200 is leaning /bending forward to stretch and decompress their back with the device 100.

After step 404, the method 400 may finish 405.

As one example of the method 400, the user 200 may place the harness loop 21 around the user's lower back portion 201 of their torso 202 and extending upward under the user's arms to the cross brace 17 and strap aperture 30 that the harness loop 21 is coupled to in step 402. With the user 200 standing as shown in FIG. 22, the base 13 may be placed within 8 inches toward the edge of a counter, workbench, or similar which approximates the height of the user's midsection in step 403. With the user 200 sitting as shown in FIG. 21, the base 13 may be placed on the support object 300 that the user 200 is sitting on in front of the user's crotch in step 403. Preferably, with the support structure 11 in the upright (the longitudinal axis 71 approximately perpendicular to the force of gravity) the user 200 may adjust the length of the harness loop 21 to remove slack. The user 200 then leans/ bends forward tilting the decompression device 100 causing the harness 12 to place upward pressure on the lumbar region of the user's back against gravitational force on the user 200 in step 404. These opposite forces in the lumbar region cause a stretch to the user's torso and back for decompression.

As another example of the method 400, the harness loop 21 may be positioned to extend down from the strap aperture 30 of the cross brace 17 that the harness loop 21 is coupled to under the user's arms and around the user's lower back (back portion 201 of the user's torso 202) in step 402. The user 200 places the base 13 directly in front of them on a surface or object that approximates the height of the mid section of the user 200 (hips to lumbar area) so that cross brace 17 and its strap aperture 30 are above or higher than the head 203 and the upright torso 202 of the user 200 in step 403. With the user 200 standing as shown in FIG. 22, the base 13 may be placed within 8 inches toward the edge of a counter, workbench, or similar which approximates the height of the user's midsection in step 403. With the user 200 sitting as shown in FIG. 21, the base 13 may be placed on the support object 300 that the user 200 is sitting on in front of the user's crotch in step 403. Preferably, with the support structure 11 in the upright (the longitudinal axis 71 approximately perpendicular to the force of gravity) the user 200 may adjust the length of the harness loop 21 to remove slack. The user 200 then leans forward bending their midsection and tilting the support structure 11 (while maintaining the longitudinal axis 71 to be substantially parallel with the user's torso 202) causing a portion of the user's weight to be transferred upward towards the strap aperture 30 of the cross brace 17 with the harness against gravity to the cross brace 17 and then down the longitudinal brace 15 to the base 13 in step 404. Generally, the lifting force on the user's torso 202 in conjunction with gravity pulling on the user's lower body works together to decompress the user's torso 202 and back, and preferably to decompress the lower back in the lumbar region.

While some exemplary shapes and sizes have been provided for elements of the device 100, it should be understood to one of ordinary skill in the art that the support structure 11, harness 12, base 13, and any other element described herein may be configured in a plurality of sizes and shapes including “T” shaped, “X” shaped, square shaped, rectangular shaped, cylinder shaped, cuboid shaped, hexagonal prism shaped, triangular prism shaped, or any other geometric or non-geometric shape, including combinations of shapes. It is not intended herein to mention all the possible alternatives, equivalent forms or ramifications of the invention. It is understood that the terms and proposed shapes used herein are merely descriptive, rather than limiting, and that various changes, such as to size and shape, may be made without departing from the spirit or scope of the invention.

Additionally, while some materials have been provided, in other embodiments, the elements that comprise the device 100 may be made from durable materials such as aluminum, steel, other metals and metal alloys, wood, hard rubbers, hard plastics, fiber reinforced plastics, carbon fiber, fiber glass, resins, polymers or any other suitable materials including combinations of materials. Additionally, one or more elements may be made from or comprise durable and slightly flexible materials such as soft plastics, silicone, soft rubbers, or any other suitable materials including combinations of materials. In some embodiments, one or more of the elements that comprise the device 100 may be coupled or connected together with heat bonding, chemical bonding, adhesives, clasp type fasteners, clip type fasteners, rivet type fasteners, threaded type fasteners, other types of fasteners, or any other suitable joining method. In other embodiments, one or more of the elements that comprise the device 100 may be coupled or removably connected by being press fit or snap fit together, by one or more fasteners such as hook and loop type or Velcro® fasteners, magnetic type fasteners, threaded type fasteners, sealable tongue and groove fasteners, snap fasteners, clip type fasteners, clasp type fasteners, ratchet type fasteners, a push-to-lock type connection method, a turn-to-lock type connection method, slide-to-lock type connection method or any other suitable temporary connection method as one reasonably skilled in the art could envision to serve the same function. In further embodiments, one or more of the elements that comprise the device 100 may be coupled by being one of connected to and integrally formed with another element of the device 100.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A decompression device, the device comprising:
a support structure comprising a longitudinal brace, the longitudinal brace having a longitudinal axis, an upper end, and a lower end;
a base coupled to the lower end;
a cross brace coupled to the upper end, the cross brace having a latitudinal axis, the latitudinal axis angled relative to the longitudinal axis between 75 and 115 degrees;
a strap guide coupled to the cross brace, the strap guide forming a strap aperture on the cross brace;
a harness, the harness having a length passing through the strap aperture on the cross brace, the harness arranged as a harness loop and configured to extend down around a back portion of an upright torso of a user, wherein the harness is configured to provide lift and decompression to the back of the user when the user leans/bends forward with the decompression device with their torso substantially parallel to the longitudinal axis.

2. The device of claim 1, wherein the base comprises a contact surface and the contact surface has a surface area of less than 30 square inches.

3. The device of claim 2, wherein the contact surface plate is configured to pivot relative to longitudinal brace.

4. The device of claim 1, wherein the longitudinal brace comprises an angled lower extension, and wherein the angled lower extension is angled relative to longitudinal axis.

5. The device of claim 1, wherein the longitudinal brace comprises a first longitudinal brace section and a second longitudinal brace section.

6. The device of claim 5, wherein the first longitudinal brace section and second longitudinal brace section are removably coupled together.

7. The device of claim 5, wherein the first longitudinal brace section and second longitudinal brace section are movably coupled together so that the first longitudinal brace section may be extended from and retracted into the second longitudinal brace section.

8. The device of claim 1, further comprising a belt configured to encircle and tighten around the user's torso.

9. The device of claim 8, wherein the belt comprises a first end and a second end, and wherein the first end and second end are removably coupled together.

10. The device of claim 1, wherein the harness loop is adjustable in length.

11. A method for back decompression using a decompression device, the device comprising:
a support structure comprising a longitudinal brace, the longitudinal brace having a longitudinal axis, a upper end, and a lower end; a base coupled to the lower end; a cross brace coupled to the upper end, the cross brace having a latitudinal axis, the latitudinal axis angled relative to the longitudinal axis between 75 and 115 degrees; a strap guide coupled to the cross brace, the strap guide forming a strap aperture on the cross brace; and a harness, the harness having a length passing through the strap aperture on the cross brace, the harness arranged as a harness loop, and the method comprising the steps of:
positioning the harness loop to extend around a back portion of an upright torso of a user;
placing a contact surface plate of the base on a support object so that the cross brace is positioned above a shoulders and the upright torso of the user; and
leaning the user's head and front shoulders/clavicle over the base while maintaining the longitudinal axis to be substantially parallel with the user's torso.

12. The method of claim 11, wherein a contact surface plate of the base is placed on a support object so that the cross brace is positioned above the shoulders and the upright torso of the user.

13. The method of claim 12, wherein the contact surface plate is configured to pivot relative to longitudinal brace.

14. The method of claim 11, wherein the longitudinal brace comprises an angled lower extension, and wherein the angled lower extension is angled relative to longitudinal axis.

15. The method of claim 11, wherein the longitudinal brace comprises a first longitudinal brace section and a second longitudinal brace section.

16. The method of claim 15, wherein the first longitudinal brace section and second longitudinal brace section are removably coupled together.

17. The method of claim 15, wherein the first longitudinal brace section and second longitudinal brace section are movably coupled together so that the first longitudinal brace section may be extended from and retracted into the second longitudinal brace section.

18. The method of claim 11, further comprising a belt configured to encircle and tighten around the user's torso.

19. The method of claim 18, wherein the belt comprises a first end and a second end, and wherein the first end and second end are removably coupled together.

20. The method of claim 11, wherein the harness loop is adjustable in length.
